(19) United States
(12) Patent Application Publication
(10) Pub. No.: US 2019/0017539 A1
(43) Pub. Date: Jan. 17, 2019

(54) STEERING SHAFT ASSEMBLY HAVING SLIDING KEYS

(71) Applicant: Steering Solutions IP Holding Corporation, Saginaw, MI (US)

(72) Inventors: William D. Cymbal, Freeland, MI (US); Jason T. Rutkiewicz, Freeland, MI (US); Joel A. Bickel, Millington, MI (US)

(21) Appl. No.: 15/646,751

(22) Filed: Jul. 11, 2017

(51) Int. Cl. F16C 3/03

(52) U.S. Cl. CPC F16C 3/03; B62D 1/20

(57) ABSTRACT

A steering shaft assembly includes an outer member and an inner member. The outer member defines a first key way that extends from an outer member first end towards an outer member second end along a first axis. The inner member has a first key that extends along the second axis from an inner member first end towards an inner member second end and is at least partially received within the first key way.

### BACKGROUND

Vehicles may be provided with an intermediate steering shaft assembly that connects a portion of a steering shaft to a steering gear input shaft. The intermediate steering shaft assembly is connected to the steering shaft and to the steering gear input shaft by respective yokes. A length of the intermediate shaft may be adjusted to aid in the assembly process of the steering shaft assembly into the vehicle.

Accordingly, it is desirable to provide an adjustable steering shaft assembly.

### SUMMARY

According to an illustrative embodiment of the present disclosure, a steering shaft assembly is provided. The steering shaft assembly includes an outer member and an inner member. The outer member has an inner wall and an outer wall that each extend from an outer member first end to an outer member second end along a first axis. The outer member defines a first key way that extends along a second axis from the inner wall towards the outer wall and extends along the first axis between the outer member first end and the outer member second end. The inner member has an outer surface that extends from an inner member first end to an inner member second end along the first axis. The inner member has a first key that extends along the second axis away from the first axis and extends along the first axis between the inner member first end and the inner member second end. The first key is at least partially received within the first key way.

According to another illustrative embodiment of the present disclosure, a steering shaft assembly is provided. The steering shaft assembly includes an outer member and an inner member. The outer member defines a first key way that extends from an outer member first end towards an outer member second end along a first axis and extends from an inner wall towards an outer wall along a second axis that is disposed transverse to the first axis. The inner member is at least partially received within the outer member. The inner member has a first key that extends along the second axis from an inner member first end towards an inner member second end and is at least partially received within the first key way.

These and other advantages and features will become more apparent from the following description taken in conjunction with the drawings.

### BRIEF DESCRIPTION OF THE DRAWINGS

The subject matter which is regarded as the present disclosure is particularly pointed out and distinctly claimed in the claims at the conclusion of the specification. The foregoing and other features, and advantages of the invention are apparent from the following detailed description taken in conjunction with the accompanying drawings in which:

FIG. 1 is a cross-sectional view of a steering shaft assembly;

FIG. 2 it is a perspective view of the steering shaft assembly;

FIG. 3 is a perspective view of an outer member of the steering shaft assembly;

FIG. 4 is a perspective view of an inner member of the steering shaft assembly;

FIGS. 5A and 5B are side and end views of an embodiment of the inner member;

FIGS. 6A and 6B are side and end views of an embodiment of the inner member;

FIGS. 7A and 7B are end views of the steering shaft assembly in a relaxed and a compressed state, respectively; and

FIGS. 8A and 8B are side views of a tool assembly applying a compressive load to the steering shaft assembly.

### DETAILED DESCRIPTION

Referring now to the Figures, the present disclosure will be described with reference to specific embodiments, without limiting same, it is to be understood that the disclosed embodiments are merely illustrative of the present disclosure that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

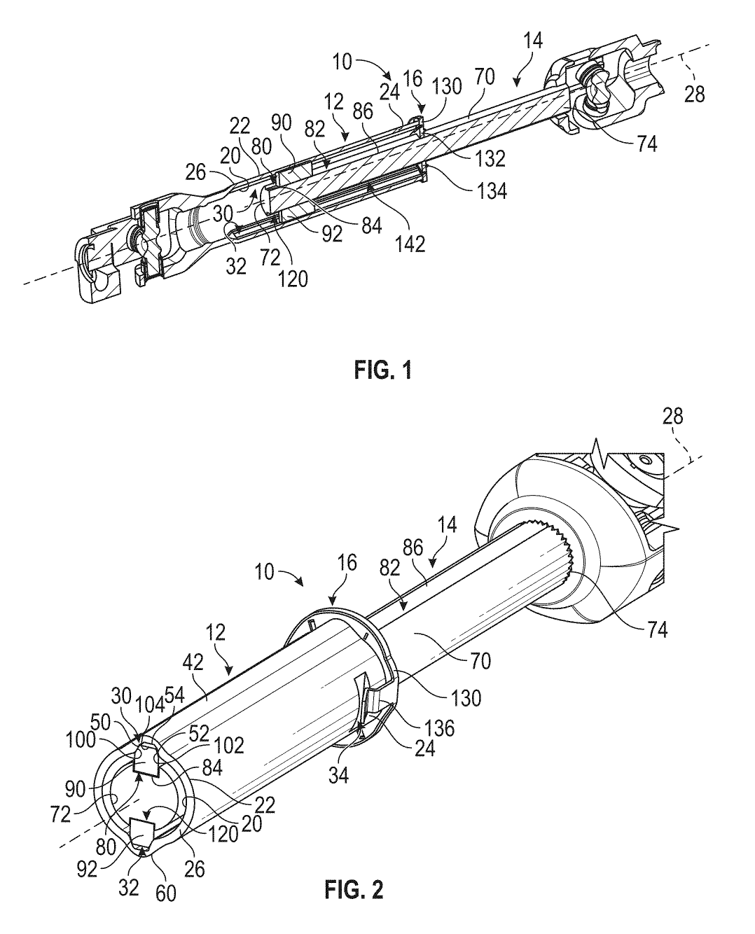

Referring to FIGS. 1 and 2, a vehicle is provided with a steering shaft assembly 10 that interconnects a steering column and a steering gear. The steering shaft assembly 10 may be commonly referred to as an intermediate shaft assembly. The steering shaft assembly 10 includes an outer member 12, an inner member 14, and a retainer 16.

The outer member 12 includes an inner wall 20 and an outer wall 22 each extending from an outer member first end 24 towards an outer member second end 26 along a first axis 28. The outer member second end 26 is operatively connected to a first yoke, as shown in FIG. 2.

Referring to FIGS. 1-3, the outer member 12 defines a first key way 30, a second key way 32, and a retaining groove 34. The first key way 30 extends along the first axis 28 between the outer member first end 24 and the outer member second end 26. The first key way 30 extends along a second axis 40, that is disposed substantially transverse to the first axis 28, from the inner wall 20 towards the outer wall 22. The extension of the first key way 30 along the second axis 40 forms or defines a first protrusion 42. The first protrusion 42 is defined by the outer wall 22 and extends along the second axis 40 away from the first axis 28. The first protrusion 42 is proximately aligned with the first key way 30 along the second axis 40.

Referring to FIGS. 2, 3, 7A, and 7B, the first key way 30 includes a first side surface 50, a second side surface 52, and a top surface 54. The first side surface 50 and the second side surface 52 extend from the inner wall 20 towards the outer wall 22 and are spaced apart from each other by the top surface 54. In at least one embodiment, the first side surface 50 and the second side surface 52 become progressively closer to each other in a direction that extends along the second axis 40 from the first axis 28 towards the top surface 54 and/or the outer wall 22.

The second key way 32 is disposed opposite the first key way 30 and has a substantially similar configuration as the first key way 30. The second key way 32 extends along the first axis 28 between the outer member first end 24 and the outer member second end 26. The second key way 32 extends along the second axis 40 from the inner wall 20 towards the outer wall 22. The extension of the second key way 32 along the second axis 40 forms or defines a second protrusion 60. The second protrusion 60 is defined by the outer wall 22 and extends along the second axis 40. The second protrusion 60 is disposed opposite the first protrusion 42. The second protrusion 60 is proximately aligned with the second key way 32 along the second axis 40.

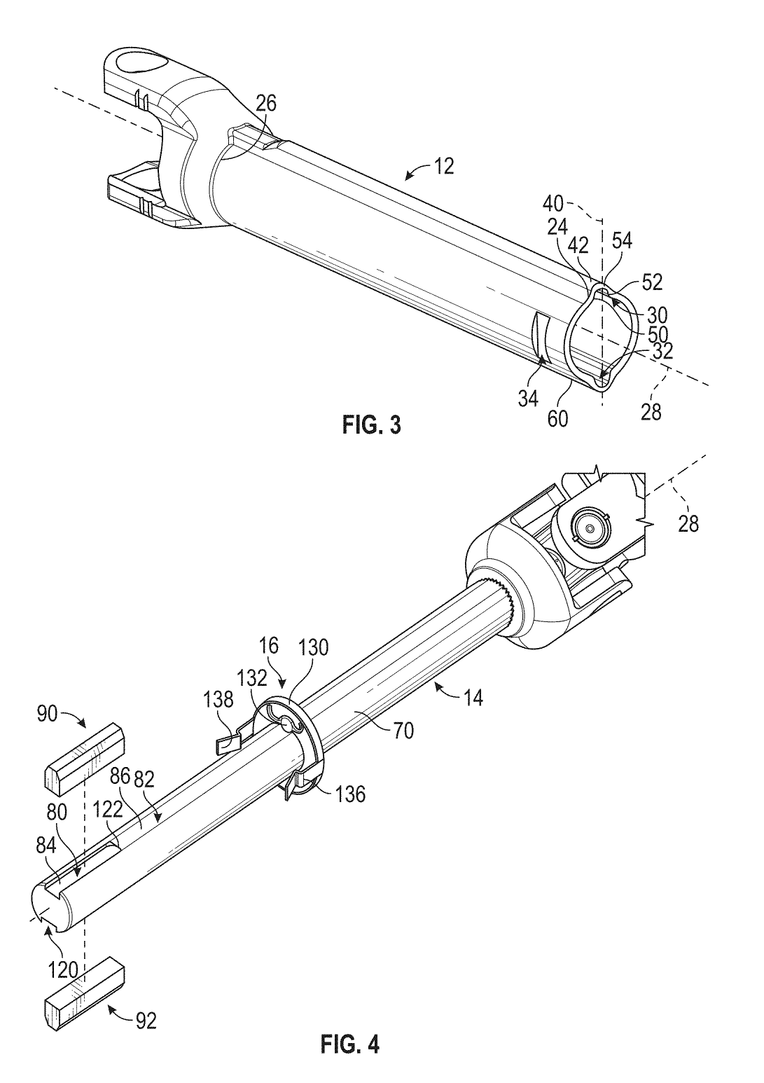

Referring to FIGS. 2 and 3, the retaining groove 34 is disposed proximate the outer member first end 24. The retaining groove 34 extends from the outer wall 22 towards the inner wall 20. The retaining groove 34 is circumferentially spaced apart from the first key way 30 and the first protrusion 42 and is circumferentially spaced apart from the second key way 32 and the second protrusion 60.

The inner member 14 is at least partially received within the outer member 12 along the first axis 28, as shown in FIGS. 1 and 2. Referring to FIGS. 1, 2, and 4, the inner member 14 includes an outer surface 70 that extends from an inner member first end 72 to an inner member second end 74 along the first axis 28. The inner member second end 74 is operatively connected to a second yoke.

The inner member 14 defines a first notch 80 and a first trough 82. The first notch 80 extends from the inner member first end 72 towards the inner member second end 74 along the first axis 28. The first notch 80 extends from the outer surface 70 towards the first axis 28 along the second axis 40. The first notch 80 has a first depth that is measured from the outer surface 70 to a floor 84 of the first notch 80.

The first trough 82 extends between an end of the first notch 80 towards the inner member second end 74 along the first axis 28. The first trough 82 extends from the outer surface 70 towards the first axis 28 along the second axis 40. The first trough 82 has a second depth that is measured from the outer surface 70 to a floor 86 of the first trough 82. The second depth being less than the first depth.

The inner member 14 includes a first key 90 and the second key 92. The first key 90 and the second key 92 are arranged to be sliding keys, enabling to the inner member 14 to slide relative to the outer member 12 along the first axis 28. The first key 90 extends from the inner member first end 72 towards the inner member second end 74 along the first axis 28. The first key 90 extends along the second axis 40 away from the first axis 28 and is at least partially received within the first key way 30, as shown in FIGS. 1, 2, 7A, and 7B.

The first key 90 includes a first key surface 100, a second key surface 102, and a third key surface 104 that extends between the first key surface 100 and the second key surface 102. The first key surface 100 and the second key surface 102 each extend from the outer surface 70 towards the third key surface 104. In at least one embodiment, the first key surface 100 and the second key surface 102 become progressively closer to each other in a direction that extends along the second axis 40 from the first axis 28 towards the third key surface 104.

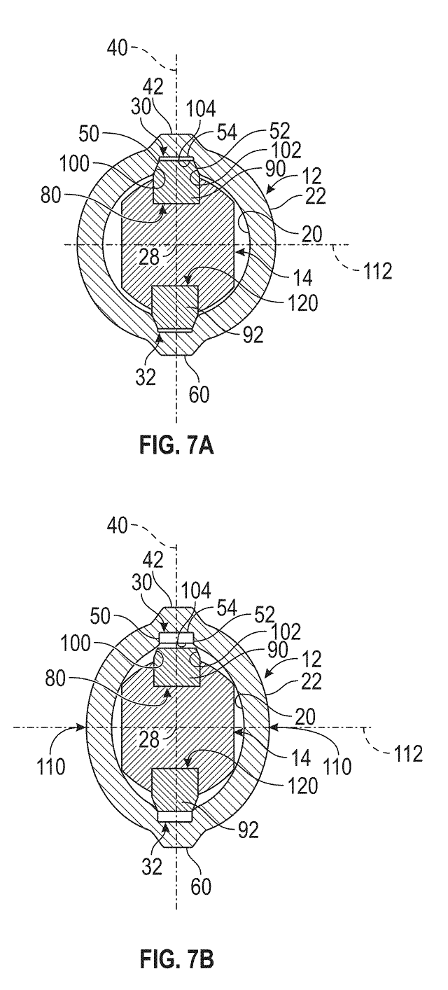

Referring to FIG. 7A, the first key surface 100 engages the first side surface 50 and the second key surface 102 engages the second side surface 52. The first key 90 has a dimensional interference with the first key way 30 that inhibits relative translation between the outer member 12 and the inner member 14 along the first axis 28. The third key surface 104 may be axially spaced apart from the top surface 54.

Referring to FIG. 7B, the first key surface 100 is spaced apart from the first side surface 50 and the second key surface 102 is spaced apart from the second side surface 52 while the compressive load 110 is applied to the outer member 12 along third axis 112 that is disposed transverse to the first axis 28 and the second axis 40. The outer member 12 elastically deforms responsive to the application of the compressive load 110 being applied along the third axis 112.

The compressive load 110 causes the elastic deformation of the outer member 12 such that the outer member 12 grows or elongates along the second axis 40 creating clearance between the first key 90 and the first key way 30 (and creates clearance between the second key 92 and the second key way 32) to facilitate relative translation between the outer member 12 and the inner member 14 along the first axis 28 to vary a total length of the steering shaft assembly 10. The total length of the steering shaft assembly 10 may be adjusted while the compressive load 110 is being applied to the outer member 12 by a tool assembly 114 to aid in the installation of the steering shaft assembly 10 into a vehicle.

The releasing of the compressive load 110 causes the outer member 12 to return to its previous shape due to its modulus of elasticity.

The second key 92 is disposed opposite the first key 90. The second key 92 has a substantially similar configuration as the first key 90. The second key 92 extends along the first axis 28 between the inner member first end 72 and the inner member second end 74. The second key 92 extends along the second axis 40 away from the first axis 28 and is at least partially received within the second key way 32, as shown in FIGS. 1, 2, 7A, and 7B.

A desired torsional resistance of the steering shaft assembly 10 may be obtained by adjusting an amount of interference between the first key 90 and the first key way 30 as well as adjusting an amount of interference between the second key 92 and the second key way 32. Furthermore, responsive to a vehicle impact event the first key 90 and the second key 92 may move axially along the first axis 28 within their respective key ways 30, 32 to enable the collapsing of the steering shaft assembly 10 and may absorb energy.

As shown in FIGS. 1 and 2, the first key 90 is received within the first notch 80 and the second key 92 is received within a second notch 120 that is disposed opposite the first notch 80 and has a substantially similar configuration as the first notch. The first key 90 abuts an end wall 122 that extends between the first notch 80 and the first trough 82 and is disposed substantially perpendicular to the floor 84 of the first notch 80 and the floor 86 of the first trough 82.

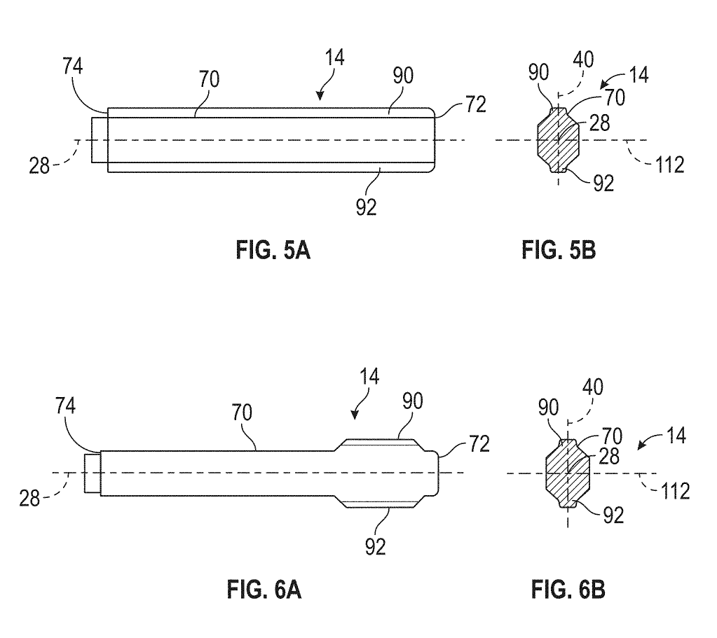

As shown in FIGS. 5A and 5B, the first key 90 and the second key 92 are defined by the outer surface 70 of the inner member 14. The first key 90 and the second key 92 extend from the inner member first end 72 towards the inner member second end 74. As configured, the first key 90 and the second key 92 are integrally formed with the inner member 14.

As shown in FIGS. 6A and 6B, the first key 90 and the second key 92 are defined by the outer surface 70 of the inner member 14. The first key 90 and the second key 92 are spaced apart from the inner member first end 72 and are spaced apart from the inner member second end 74. The first key 90 and the second key 92 are disposed closer to the inner member first end 72 than the inner member second end 74.

Referring to FIGS. 1 and 2, the retainer 16 is disposed about the inner member 14 and is disposed proximate the outer member first end 24. The retainer 16 includes a retainer body 130, a first protrusion 132, a second protrusion 134, a first retaining arm 136, and a second retaining arm 138.

Referring to FIGS. 1, 2, and 4, the retainer body 130 is disposed about the outer surface 70 of the inner member 14. The retainer body 130 is an arcuate body having an opening through which the inner member 14 extends.

The first protrusion 132 extends from an inner surface of the retainer body 130 in a direction that is disposed generally parallel to the second axis 40 and is at least partially received within the first trough 82. The second protrusion 134 is disposed opposite the first protrusion 132. The second protrusion 134 extends from the inner surface of the retainer body 130 in a direction that is disposed generally parallel to the second axis 40 and is at least partially received within a second trough 142 that is disposed opposite the first trough 82 and has a substantially similar configuration as the first trough 82.

The first retaining arm 136 and the second retaining arm 138 each extend from a face of the retainer body 130 that abuts the outer member first end 24. The first retaining arm 136 and the second retaining arm 138 extend towards the outer member second end 26. At least one of the first retaining arm 136 and the second retaining arm 38 is at least partially received within the retaining groove 34.

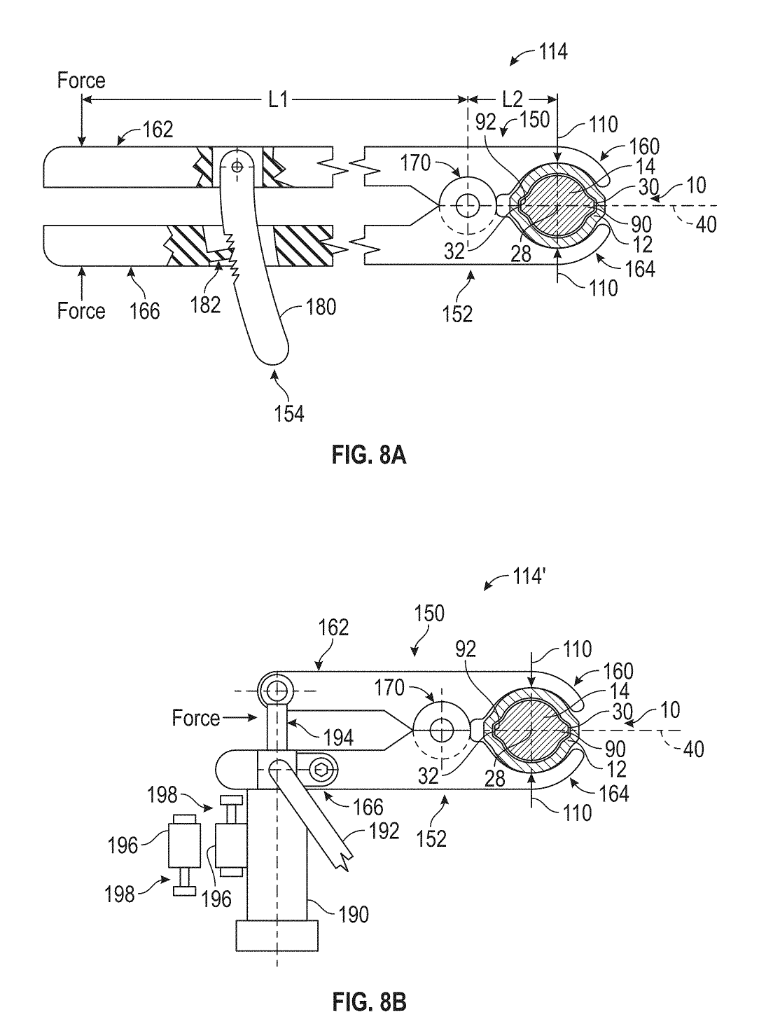

Referring to FIG. 8A, the tool assembly 114 includes a first arm 150, a second arm 152 that is pivotally or hingedly connected to the first arm 150, and a locking mechanism 154. The first arm 150 defines a first jaw 160 at a first end that is configured to engage the outer member 12 and defines a first lever arm 162 at a second end that is disposed opposite the first end. The first jaw 160 is arranged to engage a portion of the outer member 12 of the steering shaft assembly 10. The second arm 152 defines a second jaw 164 at a first end that is configured to engage the outer member 12 at a position opposite the first jaw. The second arm 152 defines a second lever arm 166 at a second end that is disposed opposite the first end.

A pivot 170 is defined between the first arm 150 and second arm 152 proximate the first jaw 160 and the second jaw 164. The pivot 170 enables to the first jaw 160 and the second jaw 164 to move relative to each other when a force is applied to at least one of the first lever arm 162 and the second lever arm 166. A length of the first lever arm 162 and the second lever arm 166 is chosen to such that a desired compressive load is applied to the outer member 12 of the steering shaft assembly 10 by the first jaw 160 and the second jaw 164, responsive to a manual force that is applied to at least one of the first lever arm 162 of the first arm 150 and the second lever arm 166 of the second arm 152.

A first distance, L1, measured between the pivot 170 and a location where the force is applied along the length of at least one of the first lever arm 162 of the first arm 150 and the second lever arm 166 of the second arm 152 is greater than a second distance, L2, measured between the pivot 170 and a location where the compressive load 110 is applied to the outer member 12 of the steering shaft assembly 10 along the length of at least one of the first jaw 160 of the first arm 150 and the second jaw 164 of the second arm 152.

The locking mechanism 154 is arranged to maintain the force applied to the outer member 12 of the steering shaft assembly 10 by the first jaw 160 and the second jaw 164 during assembly of the steering shaft assembly 10. The locking mechanism 154 includes a ratchet arm 180 and a detent 182. The ratchet arm 180 is pivotally connected to at least one of the first lever arm 162 of the first arm 150 and/or the second lever arm 166 of the second arm 152. The ratchet arm 180 may be spring loaded and may be provided with a plurality of ratchet teeth. The detent 182 is disposed on or extends from the other of the at least one of the first lever arm 162 of the first arm 150 and/or the second lever arm 166 of the second arm 152. The ratchet arm 180 maintains the compressive load on the outer member 12 of the steering shaft assembly 10 by the detent 182 engaging or interacting with the plurality of ratchet teeth of the ratchet arm 180. The compressive load may be released by applying a load to at least one of the first lever arm 162 of the first arm 150 and/or the second lever arm 166 of the second arm 152 and moving the ratchet arm 180 away from the detent 182. At least one of the first jaw 160 of the first arm 150 or the second jaw 164 of the second arm 152 moves away from the outer member 12 of the steering shaft assembly 10 to release the compressive load and permit easy removal of the tool assembly 114 from the steering shaft assembly 10 during assembly.

Referring to FIG. 8B, the tool assembly 114′ has a substantially similar configuration as the tool assembly 114 except the force applied to at least one of the first lever arm 162 of the first arm 150 and the second lever arm 166 of the second arm 152 may be applied by a clamp actuator 190. The clamp actuator 190 may be a pneumatic actuator, hydraulic actuator, electric actuator, electro-mechanical actuator, electro-hydraulic actuator or the like having a supply line 192.

The clamp actuator 190 is operatively connected to the first lever arm 162 of first arm 150 and the second lever arm 166 of the second arm 152. The clamp actuator 190 includes a drive member 194 and an actuator housing 196. The drive member 194 is operatively connected to the first lever arm 162 of the first arm 150 and responsive to operation of the clamp actuator 190, the drive member 194 moves the first lever arm 162 of the first arm 150 relative to the second lever arm 166 of the second arm 152 such that at least one of the first jaw 160 and the second jaw 164 to selectively apply the compressive load 110 to the outer member 12 of the steering shaft assembly 10.

The actuator housing 196 includes a button or a switch member 198 that is movable between a load position and an unload position. The load position is a position in which the drive member 194 moves the first lever arm 162 of the first arm 150 relative to the second lever arm 166 of the second arm 152 such that at least one of the first jaw 160 and the second jaw 164 to applies the compressive load 110 to the outer member 12 of the steering shaft assembly 10. The unload position is a position in which the drive member 194 moves the first lever arm 162 of the first arm 150 relative to the second lever arm 166 of the second arm 152 such that at least one of the first jaw 160 and the second jaw 164 to remove the compressive load 110 from the outer member 12 of the steering shaft assembly 10 to allow removal of the tool assembly 114′ from the steering shaft assembly 10 during assembly.

The present disclosure has been described in detail in connection with only a limited number of embodiments, it should be readily understood that the present disclosure is not limited to such disclosed embodiments. Rather, the present disclosure may be modified to incorporate any number of variations, alterations, substitutions or equivalent arrangements not heretofore described, but which are commensurate with the scope of the invention. Additionally, while various embodiments of the present disclosure have been described, it is to be understood that aspects of the invention may include only some of or combinations of the described embodiments. Accordingly, the present disclosure is not to be seen as limited by the foregoing description.

Having thus described the invention, it is claimed:

1. A steering shaft assembly, comprising:
an outer member having an inner wall and an outer wall, each extending from an outer member first end to an outer member second end along a first axis, the outer member defining a first key way that extends along a second axis from the inner wall towards the outer wall and extends along the first axis between the outer member first end and the outer member second end; and
an inner member having an outer surface extending from an inner member first end to an inner member second end along the first axis, the inner member having a first key that extends along the second axis away from the first axis and extends along the first axis between the inner member first end and the inner member second end, the first key being at least partially received within the first key way.

2. The steering shaft assembly of claim 1, wherein the first key way includes a first side surface and a second side surface spaced apart from the first side surface by a top surface.

3. The steering shaft assembly of claim 2, wherein the first key includes a first key surface, a second key surface, and a third key surface extending between the first key surface and the second key surface.

4. The steering shaft assembly of claim 3, wherein the top surface is axially spaced apart from the third key surface.

5. The steering shaft assembly of claim 3, wherein the first key surface engages the first side surface and the second key surface engages the second side surface.

6. The steering shaft assembly of claim 3, wherein the inner member defines a first notch that extends from the outer surface towards the first axis and extends from the inner member first end to the inner member second end along the first axis.

7. The steering shaft assembly of claim 6, the first key being received within the first notch.

8. The steering shaft assembly of claim 3, wherein the first key is defined by the outer surface of the inner member.

9. The steering shaft assembly of claim 8, wherein the first key extends from the inner member first end towards the inner member second end along the first axis.

10. The steering shaft assembly of claim 8, wherein the first key is spaced apart from the inner member first end and spaced apart from the inner member second end.

11. The steering shaft assembly of claim 3, wherein the first key surface is spaced apart from the first side surface and the second key surface is spaced apart from the second side surface, while a compressive load is applied to the outer member along a third axis that is disposed transverse to the first axis and the second axis.

12. The steering shaft assembly of claim 11, wherein the outer member and the inner member are translatable relative to each other along the first axis while the compressive load is applied to the outer member.

13. The steering shaft assembly of claim 11, wherein the compressive load is applied by a tool assembly having a first arm defining a first jaw and a second arm that is pivotally connected to the first arm and defining a second jaw, the first jaw and the second jaw being arranged to engage the outer member.

14. A steering shaft assembly, comprising:
an outer member defining a first key way that extends from an outer member first end towards an outer member second end along a first axis and extends from an inner wall towards an outer wall along a second axis that is disposed transverse to the first axis; and
an inner member that is at least partially received within the outer member, the inner member having a first key that extends along the second axis from an inner member first end towards an inner member second end and is at least partially received within the first key way.

15. The steering shaft assembly of claim 14, wherein the outer member defines a first protrusion that extends from the outer wall along the second axis and away from the first axis.

16. The steering shaft assembly of claim 15, wherein the first protrusion is proximately aligned with the first key way along the second axis.

17. The steering shaft assembly of claim 14, wherein the outer member defines a second key way that is disposed opposite the first key way and extends from the outer member first end towards the outer member second end along the first axis and extends from the inner wall towards the outer wall along the second axis.

18. The steering shaft assembly of claim 17, wherein the inner member has a second key that is disposed opposite the first key, the second key extends along the second axis and is at least partially received within the second key way.

19. The steering shaft assembly of claim 18, wherein the outer member second end is operatively connected to a first yoke.

20. The steering shaft assembly of claim 19, wherein the inner member second end is operatively connected to a second yoke.
